(19) United States
(12) Patent Application Publication
(10) Pub. No.: US 2007/0088462 A1
(43) Pub. Date: Apr. 19, 2007

(54) Garden-controlling system

(75) Inventor: Dani Peleg, Kiryat Tivon (IL)

Correspondence Address: FRISHAUF, HOLTZ, GOODMAN & CHICK, PC, 220 Fifth Avenue, 16TH Floor, NEW YORK, NY, 10001-7708, US

(73) Assignee: AP2U. NET LTD., Herzlia (IL)

(21) Appl. No.: 10/565,522

(22) PCT Filed: Jul. 21, 2004
(86) PCT No.: PCT/IL04/00663

§ 371 Date: Jun. 23, 2006

(30) Foreign Application Priority Data
Jul. 23, 2003 (IL) 157072

(51) Int. Cl. G05B 15/00

(52) U.S. Cl. 700/275; 700/284; 700/86; 700/3

(57) ABSTRACT

A garden-controller system is disclosed. The system is built up from a plurality of area-controllers, a garden-controller that is located in each controlled garden in order to control the area-controllers in its' garden and a dedicated software installed on a computing means or in a dedicated web site on the Internet. Each of these area-controllers is programmed to operate and control the needed tasks in the area where the area-controller is located. The program can be updated and/or modified by the garden-controller. The system and its' parts capable to communicate via any communication infrastructure including the Internet.

### FIELD OF THE INVENTION

The present invention relates to an irrigation system and method. More specifically, the present invention relates to a garden-controlling system and method that enables to control plurality of gardens by using dedicated software installed on a personal computer and/or an Internet web site.

### BACKGROUND OF THE INVENTION

Known irrigation systems are usually a stand-alone controller that opens and closes irrigation valves according to a time sequence. These systems are locally programmed and there is no central unit, which enables control of a plurality of such systems.

The advantage of the present invention is that it provides an ability to control a plurality of gardens or a plurality of areas in a garden by using a garden controller that can be managed and programmed by a computing means or an Internet web site, with a friendly software, via any kind of communication method or system.

### SUMMARY OF THE INVENTION

According to the teaching of the present invention there is provided a garden-controlling system comprised of:
a) a plurality of area-controllers, each of the area controller has a programming capability and communication capability and wherein each of the area-controllers capable to collect and transfer information;
b) a garden-controller with a programming capability and a communication capability enables to communicate with a computing means and to communicate with each of the area-controllers in order to program, update and/or modify the area-controllers' program; and
c) a programming-software is installed on a computing means, which enables it to program, update and/or modify the garden-controllers' program via the communication capability.

By a preferred embodiment of the present invention it is provided a garden-controlling system, wherein the programming-software operative fore:
on-screen programming—a specific program for each of the area-controllers—of irrigation, fertilization, illumination and apparatus activating of each area of a given garden;
on-screen programming of the garden-controller;
setup of the operation-criteria of each of the programs;
pulling task-performance information and other collected information from the area-controllers; and
update and/or modify each of the programs via the communication capability.

By another preferred embodiment of the present invention it is provided a garden-controlling system, further includes an Internet web site. The web site communicates with a plurality of garden-controllers and holds updated information regarding each garden that is controlled by the garden-controller and wherein the web site enables to pull updated information from each garden-controller and enables to use the programming-software to program, update and/or modify each of the garden-controllers' programs.

By another preferred embodiment of the present invention it is provided a garden-controlling system, wherein each of the communication capabilities can be one or plurality of the followings:
phone line or wire communication;
cellular communication;
electromagnetic waves wireless communication;
blue-toot communication;
electro-optical communication; and/or;
any other communication method or system.

By another preferred embodiment of the present invention it is provided a garden-controlling system, wherein each of the area-controller operative—according to a program, a predetermined criteria or a command from the garden-controller—for at least one of the following:
opening and closing irrigation valves;
activating a water pump;
opening and closing fertilization valves;
activating a fertilization pump;
turns illumination means on and off; and/or
activating any other apparatus or system.

By another preferred embodiment of the present invention it is provided a garden-controlling system, further includes a plurality of sensors that are connected to at least part of the area-controllers and wherein each of the area-controllers collects information from the sensors, uses the information for local use and transmits the information to the garden-controller via the communication capability and wherein the programming-software can pull the information from the garden-controller.

By another preferred embodiment of the present invention it is provided a garden-controlling system, wherein the sensors could be any combination of the followings:
rain sensor
ground humidity sensor
water supply sensor
fertilizer sensor
pressure sensor
any other sensor

By another preferred embodiment of the present invention it is provided a garden-controlling system, wherein the programming-software enables to program each of the area-controller correspondingly to the location of the area-controller, in order to activate irrigation, fertilization and illumination according to the location area structure and time sequence.

By another preferred embodiment of the present invention it is provided a garden-controlling system, wherein the garden-controller is programmed, using the programming software, to update or modify the area-controllers' program according to a predetermined criteria, sensors information that is collected in a specific area and/or commands from the programming-software.

By another preferred embodiment of the present invention it is provided a garden-controlling system, wherein the area-controller further includes a solar power supply.

By another preferred embodiment of the present invention it is provided a garden-controlling system, wherein the area-controller and/or the garden-controller capable to transmit an alarm—to a predetermined communication address or phone number, via the communication capability—according to a predetermined criteria.

By another preferred embodiment of the present invention it is provided a garden-controlling system, wherein the area-controller and/or the garden- controller capable to receive a code from any communication apparatus and performs predetermined actions.

According to another aspect of the present invention, it is provided a method for garden controlling comprising of the following steps:
a) locating a plurality of area-controllers, each of the area controller has a programming capability and communication capability and wherein each of said area-controllers capable to collect and transfer information from a plurality of sensors;
b) controlling, updating and modifying the area-controllers by means of a garden-controller, the garden-controller has a programming capability and a communication capability and enables to communicate with a computing means and to communicate with each of the area-controllers; and
c) programming, updating and modifying the garden-controller by means of programming-software that is installed on a computing means, via the communication capability of the garden-controller.

According to another aspect of the present invention, it is provided the method for garden controlling, further includes the step of enabling the connection of the garden-controller to an Internet web site, the web site holds update information regarding the garden-controller and wherein the web site enables to pull updated information from the garden-controller and enables to use the programming-software to program, update and/or modify each of the garden-controllers' program.

### BRIEF DESCRIPTION OF THE FIGURES

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the figures:

FIG. 1 illustrates a block diagram of a preferred embodiment of an area-controller.

FIG. 2 illustrates a block diagram of a single garden system.

FIG. 3 illustrates a plurality of gardens and the way they are controlled by the system.

### DESCRIPTION OF THE PREFERED EMBODIMENTS

The principles and operation of the garden-control system according to the present invention may be better understood with reference to the drawing and the accompanying description.

The present invention is a garden-controller system. The system is built up from a plurality of area-controllers, a garden-controller that is located in each controlled garden in order to control the area-controllers in its' garden and a dedicated software installed on a computing means or in a dedicated web site on the Internet. The parts of the system have a communication capability and can communicate each other via a plurality of communication methods.

Each of these area-controllers is programmed to operate and control the needed tasks in the area where the area-controller is located. The program can be updated and/or modified by the garden-controller. The needed tasks include water valves controlling, light controlling, fertilization controlling, activating a camera to view the area, collecting information from a plurality of sensors and other local tasks.

All the area-controllers in a garden are controlled by a garden-controller, which via a communication capability receives information from each area-controller, manages the area-controllers and capable to update and/or modify the program of each area-controller. With a dedicated software that is installed on a personal computer or alike or located in a dedicated web site, a user can receive information from a garden or a number of gardens and program whole tasks of the garden that can be performed automatically. The two-ways of communication between the user, the computer and the web site can be in any kind of communication method and enables the user to receive alarms from the garden-controller and to send a code to the garden-controller that is decoded to a predetermined program or task.

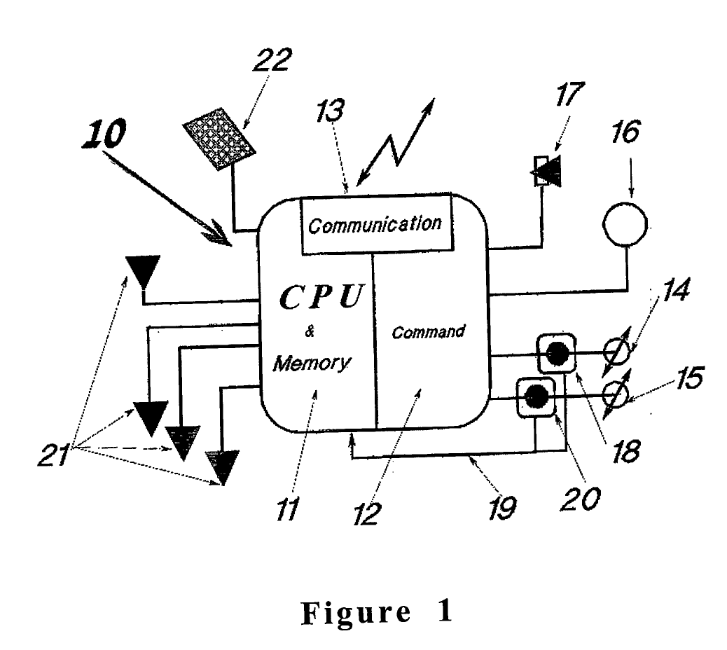

Referring now to the drawing, FIG. 1 illustrates a block diagram of a preferred embodiment of an area-controller 10. The area-controller 10 has a CPU and memory 11 to hold a program and information and to perform the program, which activates the command unit 12 to perform tasks and use the communication unit 13 to establish two-ways communication. The area-controller 10—via the command unit 12—can control the water valves 14 and fertilization valves 15 according to the information that is received from a water-supply-measure 18 and fertilization-supply-measure 20. The area-controller 10 can also turn on or off the garden illumination 16 and activate a camera 17 for sending garden images to the user. The area-controller 10 has a plurality of sensors 21 to collect different kinds of information e.g., rain sensor, ground humidity sensor, water supply sensor, fertilizer sensor, pressure sensor or any other sensor. The power that is supplied to the area-controller 10 can differ, including a solar power supply 22.

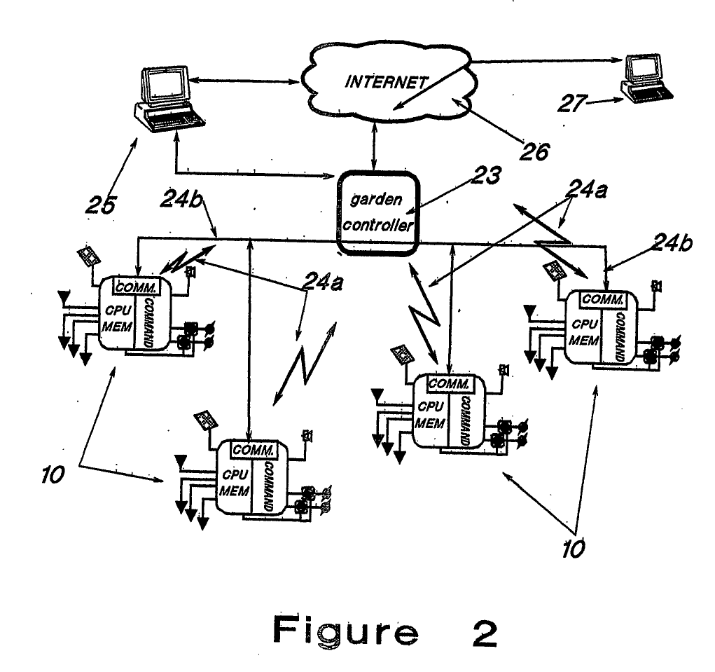

FIG. 2 illustrates a block diagram of a single garden system. A plurality of area-controllers 10 are spread in a garden each one in a specific area. The area-controllers 10 are connected—either by a wireless connection 24a or physical connection 24b —to a garden controller 23, which manages the area-controllers 10 and are capable to modify or update their programs. The garden-controller 23 holds in memory the whole information, programs and parameters regarding to each area-controller 10. In order to program the garden-controller 23 or to update or modify the program, the garden-controller 23 can be connected to a computer 25 or to a web site on the Internet 26 or both. Dedicated software is installed in the computer 25 or on the web site 26. The information corresponding to the garden is saved in the garden-controller's 23 memory and in additional can be saved in the computers' memory 25 and on the web site 26. By using a remote computer 27 that is connected to the Internet 26, a user can pull information corresponding to his garden and capable—via the web site 26—to program, update or modify the program of the garden-controller 23. The garden-controller 23 can send an alarm to the user—via the computer 25 or by E-mail via the web site 26 or to a predetermined phone number. In such a case the user capable to send a code—using the communication capability of the garden-controller 23—and this code is decoded to predetermined commands.

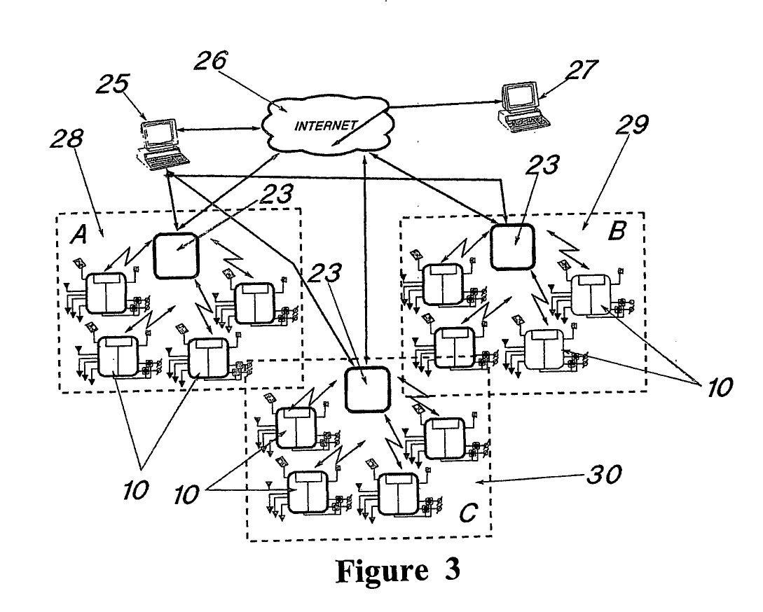

FIG. 3 illustrates a plurality of gardens and the way they are controlled by the system. The system enables to manage a plurality of garden from a single PC 25&27 or web site 26. In the figure garden A 28, garden B 29 and garden C 30 are controlled from a single PC 25 or from the web site 26. In each garden a plurality of area-controllers 10 are spread in each garden and connected to the local garden-controller 23. The garden-controllers 23 can be connected to a PC 25 or to a web site 26, which can be used from a remote PC 27. The information corresponding to each garden is saved in the computers' memory 25 and in the web site 26. In this way the user can pull information regarding to each garden and, according to the pulled information, can update or modify the program of each garden-controller 23. Each of the garden-controllers 23 can send an alarm to the user—via the computer 25 or by E-mail via the web site 26 or to a predetermined phone number. In such a case the user capable to send a code to a specific garden-controller 23—using its' communication capability—and this code is decode to predetermined commands.

Although the invention has been described in conjunction with specific embodiments thereof, it is evident that many alternatives, modifications and variations will be apparent to those skilled in the art, accordingly, it is intended to embrace all such alternatives, modifications and variations that fall within the spirit and broad scope of the appended claims.

What is claimed is:

1. A garden-controlling system, said system comprising:
a) a plurality of area-controllers, each of said area controller has a programming capability and communication capability and wherein each of said area-controllers capable to collect and transfer information;
b) a garden-controller with a programing capability and a communication capability enables to communicate with a computing means and to communicate with each of said area-controllers in order to program, update and/or modify said area-controllers' program; and
c) a programming-software to be installed on a computing means enables to program, update and/or modify said garden-controllers' program via said communication capability.

2. The system of claim 1, wherein said programming-software operative fore:
on-screen programming—a specific program for each of said area-controllers—of irrigation, fertilization, illumination and apparatus activating of each area of a given garden;
on-screen programming of said garden-controller;
setup the operation-criteria of each of said programs;
a pulling task-performance information and other collected information from said area-controllers; and
update and/or modify each of said programs via said communication capability.

3. The system of claim 1, further includes an Internet web site, said web site communicates with a plurality of garden-controllers, said web site holds updated information regarding each garden that is controlled by said garden-controller and wherein said web site enables to pull update information from each garden-controller and enables to use said programing-software to program, update and/or modify each of said garden-controllers' program.

4. The system of claim 1, wherein each of said communication capabilities can be one or plurality of the following:
phone line or wire communication;
cellular communication;
electromagnetic waves wireless communication;
blue-toot communication;
electro-optical communication; and/or;
any other communication method or system.

5. The system of claim 1, wherein each of said area-controller operative—according to a program, a predetermined criteria or a command from the garden-controller—for at least one of the followings:
opening and closing irrigation valves;
activating a water pump;
opening and closing fertilization valves;
activating a fertilization pump;
turns illumination means on and off; and/or
activating any other apparatus or system.

6. The system of claim 1, further includes a plurality of sensors that are connected to at least part of said area-controllers and wherein each of said area-controllers collects information from said sensors, uses said information for local use and transmits said information to said garden-controller via said communication capability and wherein said programming-software can pull said information from said garden-controller.

7. The system of claim 6, wherein said sensors could be any combination of the followings:
rain sensor
ground humidity sensor
water supply sensor
fertilizer sensor
pressure sensor
any other sensor.

8. The system of claim 1, wherein said programming-software enables to program each of said area-controller correspondingly to the location of said area-controller, in order to activate irrigation, fertilization and illumination according to the location area structure and time sequence.

9. The system of claim 8, wherein said garden-controller is programmed, using said programming software, to update or modify said area-controllers' program according to a predetermined criteria, sensors information that is collected in a specific area and/or commands from said programming-software.

10. The system of claim 1, wherein said area-controller further includes a solar power supply.

11. The system of claim 1, wherein said area-controller and/or said garden-controller capable to transmit an alarm—to a predetermined communication address or phone number, via said communication capability—according to a predetermined criteria.

12. The system of claim 1, wherein said area-controller and/or said garden-controller capable to receive a code from any communication apparatus and performs predetermined actions.

13. A method for garden controlling, said method comprised of the following steps:
a) locating a plurality of area-controllers, each of said area controller has a programming capability and communication capability and wherein each of said area-controllers capable to collect and transfer information from a plurality of sensors;
b) controlling, updating and modifying said area-controllers by means of a garden-controller, said garden-controller has a programming capability and a communication capability and enables to communicate with a computing means and to communicate with each of said area-controllers; and
c) programming, updating and modifying said garden-controller by means of programming-software that is installed on a computing means, via said communication capability of said garden-controller.

14. The method of claim 13, further includes the step of enabling the connection of said garden-controller to an Internet web site, said web site holds update information regarding said garden-controller and wherein said web site enables to pull update information from said garden-controller and enables to use said programming-software to program, update and/or modify each of said garden-controllers' program.
